(19) United States
(12) Patent Application Publication
(10) Pub. No.: US 2007/0095190 A1
(43) Pub. Date: May 3, 2007

(54) Disk cutter with plurality of thicker portions

(75) Inventor: Tanehiko Asada, Fukuroi (JP)

Correspondence Address: RADER FISHMAN & GRAUER PLLC, LION BUILDING, 1233 20TH STREET N.W., SUITE 501, WASHINGTON, DC, 20036, US

(73) Assignee: Tenryu Seikyo Kabushiki Kaisha

(21) Appl. No.: 11/362,746

(22) Filed: Feb. 28, 2006

(30) Foreign Application Priority Data
Nov. 2, 2005 (JP) 2005-319314

(51) Int. Cl. B27B 33/02

(52) U.S. Cl. 83/848

(57) ABSTRACT

A disk cutter including an annular disk-shaped base adapted to be driven about an axis of rotation, the base having a first thickness, a plurality of tip supports formed along the outer circumference of the base integrally therewith so that a gullet is defined between adjacent ones of the tip supports, a plurality of tip inserts respectively fixed to the tip supports, each of the tip inserts having a second thickness, and a plurality of thicker portion formed along a trailing end of each tip support in respect of rotation of the base, the thicker portion having a third thickness. The third thickness is greater than the first thickness and less than the second thickness.

### BACKGROUND OF THE INVENTION

1. Field of the Invention

The present invention relates to a disk cutter or circular saw suitable for cutting of steel, wood, ALC (autoclaved lightweight concrete), woody cement, etc.

2. Description of the Related Art

A disk cutter or circular saw including a base disk having a plurality of tip supports arranged along the outer circumference and a plurality of hardened cutting tip inserts (cutter inserts) respectively fixed to the tip supports by brazing or the like is frequently used for board cutting or the like. A plurality of the tip supports are spaced at given intervals in the circumferential direction of the base disk or annular disk-shaped base, and a gullet is defined between adjacent ones of the tip supports. Each tip support has a recess, and each hardened cutting tip insert is fixed in the recess of the corresponding tip support by brazing or the like.

The base disk has a first mounting hole at its central portion, and a boss portion of a collar is inserted through the first mounting hole. The boss portion of the collar is formed with a second mounting hole, and a rotating shaft of a rotary tool is inserted through the second mounting hole. The disk cutter is mounted to the rotary tool by fastening the base disk through the collar to the rotating shaft with a bolt.

The annular disk-shaped base of such a disk cutter has a small thickness as compared with its outer diameter. Accordingly, resonance or transverse vibration occurs under a certain condition in cutting a work material or in idling, causing not only a high level of noise, but also a remarkable degradation in cutting performance.

To suppress the resonance or transverse vibration in cutting a work material, Japanese Patent Laid-open No. Hei 10-296529 has proposed a disk cutter or circular saw wherein a vibration suppression plate is fixed to a side surface of the disk-shaped base by means of bolts and nuts. In this related art disk cutter, the vibration suppression plate as a separate member is fixed to a side surface of the disk-shaped base by means of bolts and nuts. Accordingly, the structure of the disk cutter is complicated and the weight of the disk cutter is also increased. Further, there is a case that the size of a work material to be cut is limited.

### SUMMARY OF THE INVENTION

It is therefore an object of the present invention to provide a disk cutter which can suppress the transverse vibration in cutting a work material with a simple structure without an increase in weight.

In accordance with an aspect of the present invention, there is provided a disk cutter comprising an annular disk-shaped base adapted to be driven about an axis of rotation, the base having a first thickness; a plurality of tip supports formed along the outer circumference of the base integrally therewith so that a gullet is defined between adjacent ones of the tip supports; a plurality of tip inserts respectively fixed to the tip supports, each of the tip inserts having a second thickness; and a plurality of thicker portions each formed along a trailing end of each tip support in respect of rotation of the base, the thicker portions having a third thickness; the third thickness being greater than the first thickness and less than the second thickness.

Preferably, the thicker portion is formed by plastic deformation, e.g., hot forging of the outer circumference of each tip support.

In accordance with another aspect of the present invention, there is provided a disk cutter including an annular disk-shaped base adapted to be driven about an axis of rotation, the base having a first thickness; a plurality of tip supports formed along the outer circumference of the base integrally therewith so that a gullet is defined between adjacent ones of the tip supports; a plurality of tip inserts respectively fixed to the tip supports, each of the tip inserts having a second thickness; and a plurality of thicker portions each continuously formed over the range from the outer circumference of each tip support to the inner wall of the gullet between adjacent ones of the tip inserts, the thicker portion having a third thickness; the third thickness being greater than the first thickness and less than the second thickness.

In accordance with a fourth aspect of the present invention, there is provided a disk cutter including an annular disk-shaped base adapted to be driven about an axis of rotation, the base having a first thickness; a plurality of tip supports formed along the outer circumference of the base integrally therewith so that a gullet is defined between adjacent ones of the tip supports; a plurality of tip inserts respectively fixed to the tip supports, each of the tip inserts having a second thickness; and a plurality of thicker portions each formed along a trailing end of each of some of the tip supports in respect of rotation of the base, the some of the tip supports being arranged at intervals of two or more tip supports, the thicker portions having a third thickness; the third thickness being greater than the first thickness and less than the second thickness.

In accordance with a still further aspect of the present invention, there is provided a disk cutter including an annular disk-shaped base adapted to be driven about an axis of rotation, the base being composed of an inner circumferential portion having a first thickness and an outer circumferential portion having a second thickness greater than the first thickness; a plurality of tip supports formed along the outer circumference of the outer circumferential portion of the base integrally therewith so that a gullet is defined between adjacent ones of the tip supports; and a plurality of tip inserts respectively fixed to the tip supports, each of the tip inserts having a third thickness; the second thickness being less than the third thickness.

The above and other objects, features and advantages of the present invention and the manner of realizing them will become more apparent, and the invention itself will best be understood from a study of the following description and appended claims with reference to the attached drawings showing some preferred embodiments of the invention.

### BRIEF DESCRIPTION OF THE DRAWINGS

FIG. 1 is a side view of a part of a disk cutter according to a first preferred embodiment of the present invention;

FIG. 2 is an enlarged cross section taken along the line II-II in FIG. 1;

FIG. 3 is an enlarged cross section taken along the line III-III in FIG. 1;

FIG. 4 is a side view of a part of a disk cutter according to a second preferred embodiment of the present invention;

FIG. 5 is a side view of a part of a disk cutter according to a third preferred embodiment of the present invention;

FIG. 6 is a side view of a part of a disk cutter according to a fourth preferred embodiment of the present invention;

FIG. 7 is an enlarged cross section taken along the line VII-VII in FIG. 6;

FIG. 8 is a side view of a part of a disk cutter according to a fifth preferred embodiment of the present invention;

FIG. 9A is a cross section taken along the line IX-IX in FIG. 8; and

FIG. 9B is similar to FIG. 9A but showing another embodiment.

### DETAILED DESCRIPTION OF THE PREFERRED EMBODIMENTS

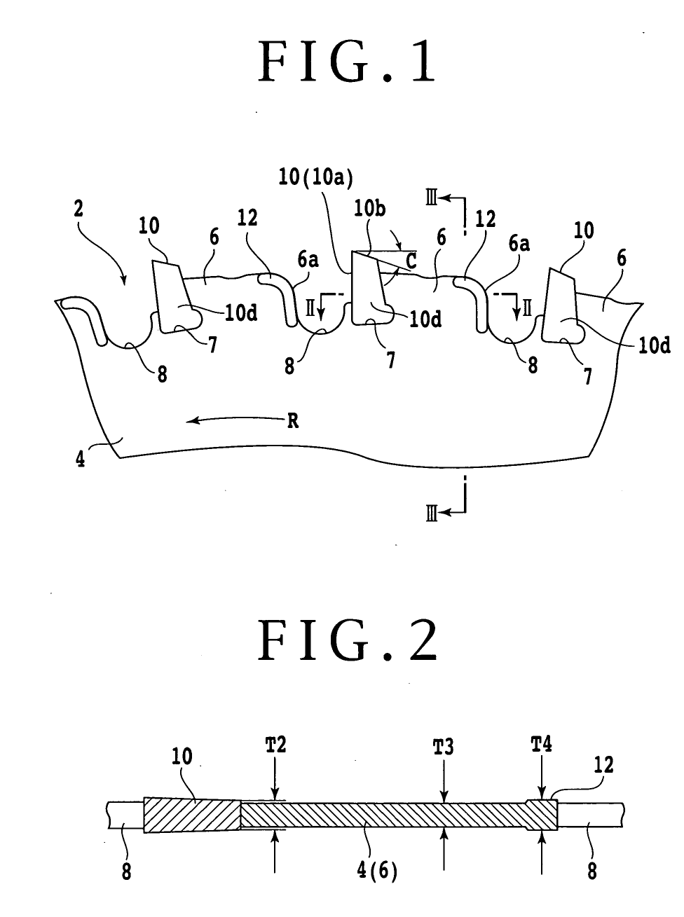

A disk cutter 2 according to a first preferred embodiment of the present invention will now be described with reference to FIGS. 1 to 3. The disk cutter 2 is suitable for cutting of steel, wood, ALC (autoclaved lightweight concrete), woody cement, etc. In this preferred embodiment, the disk cutter 2 includes an annular disk-shaped base (base disk) 4 having an outer diameter of about 185 mm and a reference thickness T3 of about 1.6 mm and a plurality of (e.g., 48) saw-toothed tip supports 6 formed along the outer circumference of the base disk 4 at equal intervals or unequal intervals. A gullet 8 is defined between adjacent ones of the tip supports 6. The base disk 4 is formed of steel such as JIS SKS51 (alloy tool steel), JIS SK5 (carbon tool steel), or JIS SK6 (carbon tool steel). Each tip support 6 is formed with a recess 7, and a tip insert 10 is fixed in each recess 7 by brazing or the like. Each tip insert 10 is formed of cemented carbide.

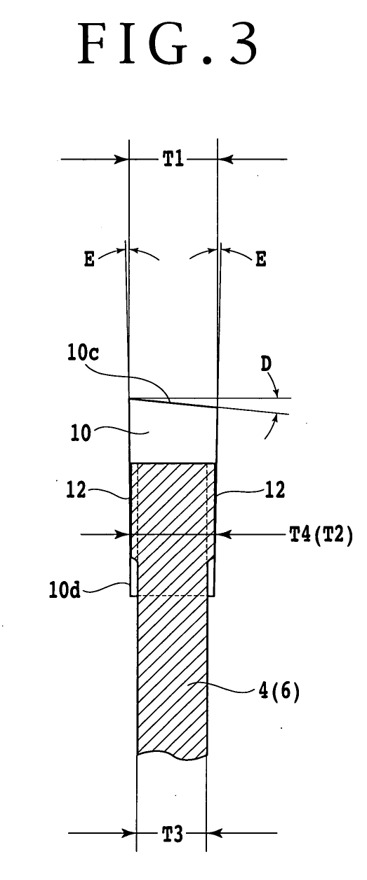

Each tip insert 10 has a face 10a having a rake angle of about 0°, a flank 10b having a clearance angle C of about 17°, and a cutting edge 10c having a transverse clearance angle D (see FIG. 3) of about 4°. The cutting edges 10c of any adjacent ones of the tip inserts 10 are oppositely inclined. Further, the side centripetal angle E of each tip insert 10 is set to about 1°, and the thickness of each tip insert 10 is set in such a manner that the thickness T1 of the cutting edge 10c is about 2 mm and the thickness T2 of a base portion 10d is about 1.9 mm. The angles and dimensions of each tip insert 10 are suitably set according to the kind of a work material to be cut.

The disk cutter 2 is rotated in a direction shown by an arrow R in FIG. 1. Each tip support 6 has a trailing end portion 6a in respect of rotation of the disk cutter 2. The trailing end portion 6a is formed with a thicker portion or protruded portion 12 increased in thickness along the thickness of the base disk 4. The thicker portion 12 is formed by plastic deformation of the trailing end portion 6a. For example, the plastic deformation of the trailing end portion 6a is performed by hot forging such that the trailing end portion 6a is hammered with heat. The thickness T4 of the thicker portion 12 is set greater than the reference thickness T3 of the base disk 4 and less than the thickness T1 of the cutting edge 10c. In this preferred embodiment, the thickness T4 is set to about 1.9 mm, which is almost equal to the thickness T2 of the base portion 10d of each tip insert 10. While the thicker portion 12 is formed on each tip support 6 in this preferred embodiment, the thicker portion 12 may be formed at intervals of one tip supports 6 or two or more tip supports 6.

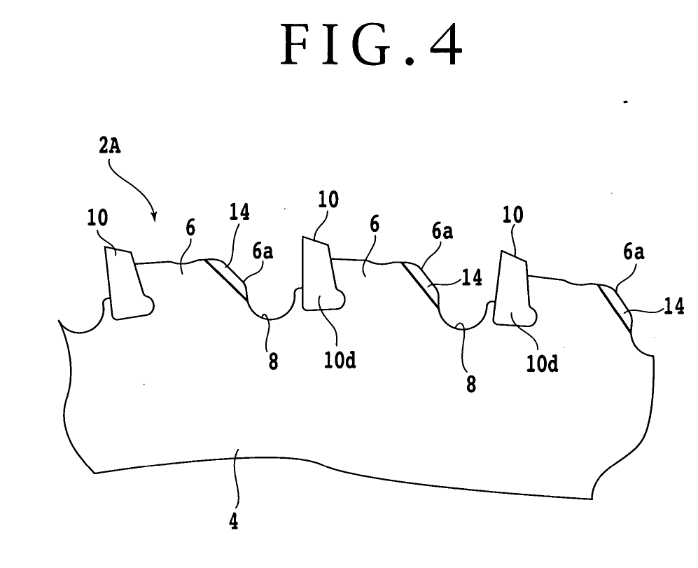

Referring to FIG. 4, there is shown a side view of a part of a disk cutter 2A according to a second preferred embodiment of the present invention. In the disk cutter 2A, each tip support 6 has an inclined trailing end portion 6a. The inclined trailing end portion 6a is formed with a thicker portion 14 by hot forging. The other configuration is similar to that of the first preferred embodiment shown in FIG. 1.

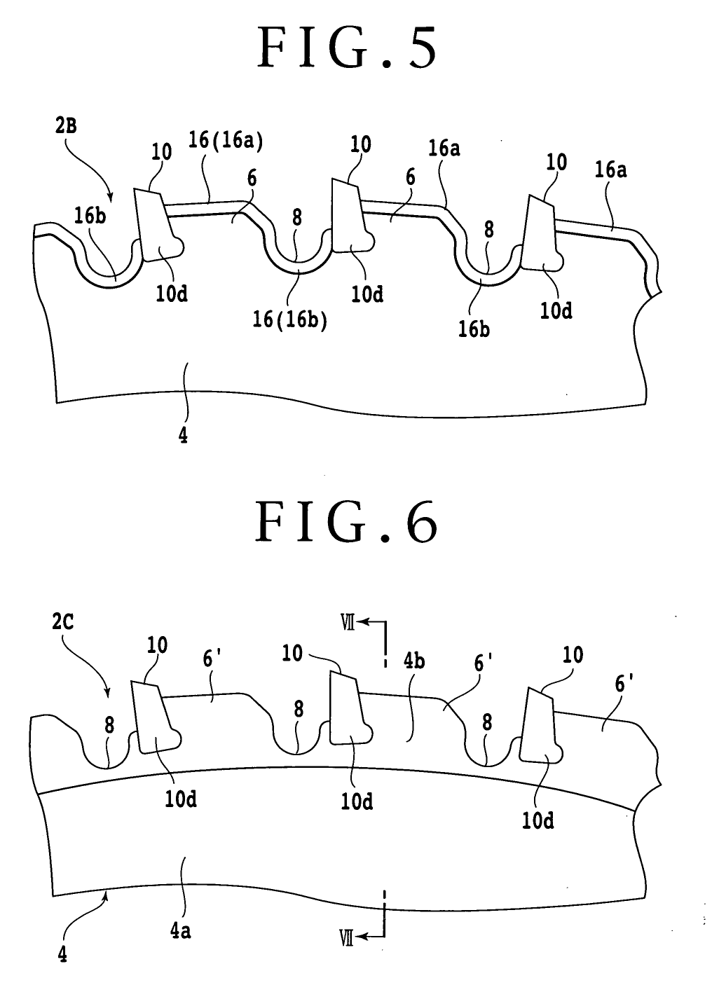

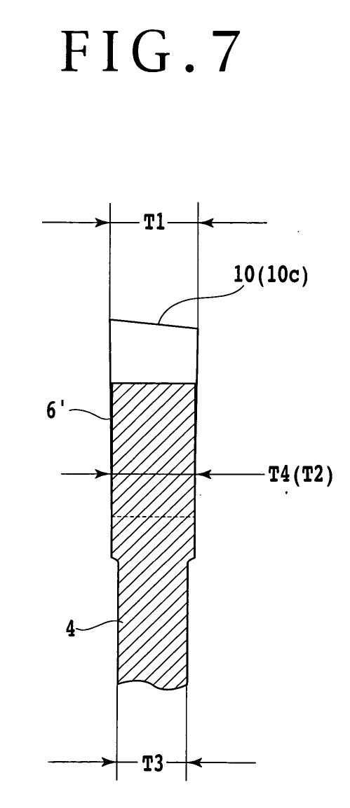

Referring to FIG. 5, there is shown a side view of a part of a disk cutter 2B according to a third preferred embodiment of the present invention. In the disk cutter 2B, a thicker portion 16 is continuously formed over the range from the outer circumference of the tip support 6 to the inner wall of the gullet 8 between adjacent ones of the tip inserts 10. Further, the trailing end of the thicker portion 16 in respect of rotation of the disk cutter 2B abuts against the base portion 10d of each tip insert 10. In this preferred embodiment, the thicker portion 16 is formed by hot rolling of the outer circumference of the tip support 6 and the inner wall of the gullet 8. Although not especially shown, a thicker portion 16a formed along the outer circumference of the tip support 6 and a thicker portion 16b formed along the inner wall of the gullet 8 may be discontinued in the circumferential direction of the base disk 4. In other words, the thicker portions 16a and 16b constituting the thicker portion 16 may be separated from each other. The other configuration is similar to that of the first preferred embodiment shown in FIG. 1.

Referring to FIG. 6, there is shown a side view of a part of a disk cutter 2C according to a fourth preferred embodiment of the present invention. In the disk cutter 2C, the base disk 4 is composed of an inner circumferential portion 4a having the reference thickness T3 and an outer circumferential portion 4b having a thickness greater than the reference thickness T3 and equal to the thickness T2 of the base portion 10d of each tip insert 10. The base disk 4 having such a structure is formed by first preparing a disk having the thickness T2 and next grinding the inner circumferential portion 4a so as to obtain the thickness T3. A plurality of tip supports 6′ are formed along the outer circumference of the outer circumferential portion 4b, and the tip insert 10 is fixed to each tip support 6′ by brazing or the like. In this preferred embodiment, the thickness of each tip support 6′ is a uniform thickness greater than the thickness T3 of the inner circumferential portion 4a and less than the thickness T1 of the cutting edge 10c of each tip insert 10. Accordingly, unlike the first to third preferred embodiments, it is not necessary to form a thicker portion on each tip support 6′, and it is also not necessary to perform any machining for forming such a thicker portion.

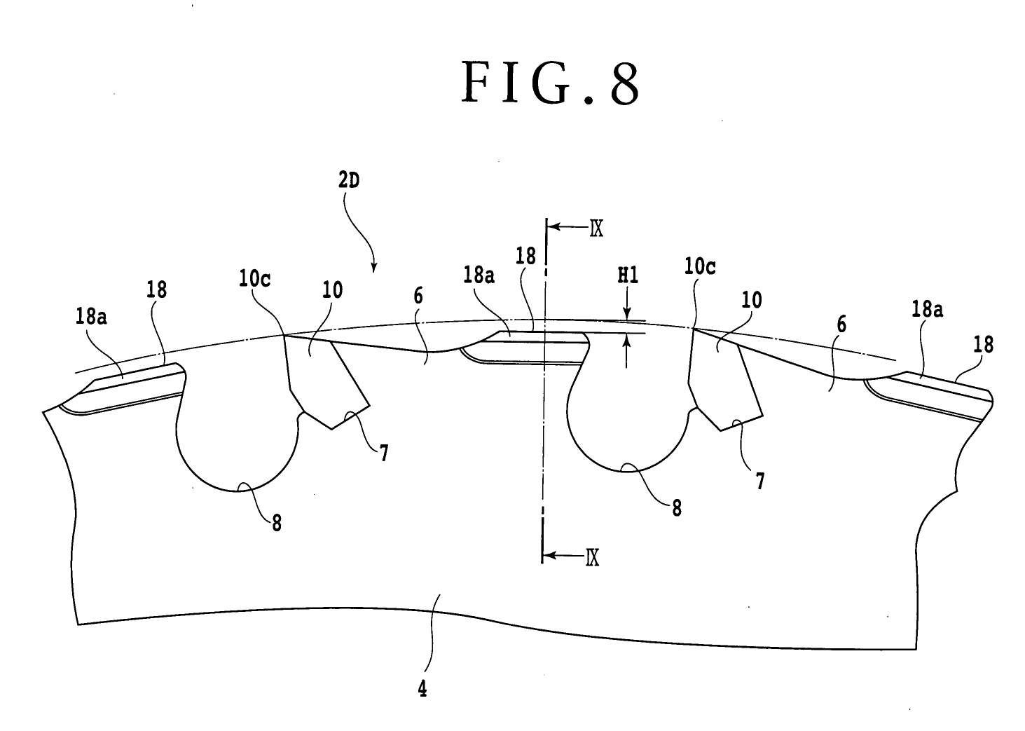

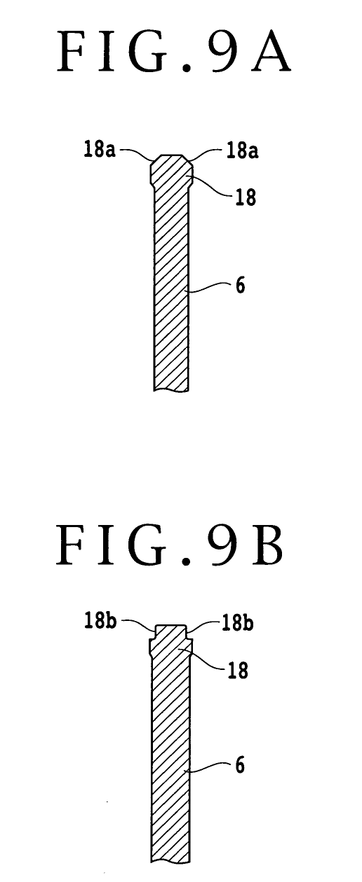

Referring to FIG. 8, there is shown a side view of a part of a disk cutter 2D according to a fifth preferred embodiment of the present invention. In the disk cutter 2D, each tip support 6 is formed with a thicker portion 18 increased in thickness along the thickness of the base disk 4. The thicker portion 18 is formed by plastic deformation of part of the tip support 6 by hot forging. As shown in FIG. 9A, a chamfer 18a is formed at each top corner of the thicker portion 18. In this embodiment, a difference H1 between height of the thicker portion 18 and height of the cutting edge 10c of the tip insert 10 is set very small, such as 0.35 mm so that the disk cutter 2D is suitable for cutting steels or other metal works. As the chamfer 18a is formed at each top corner of the thicker portion 18, small tips of the cut work material are less likely to adhere to the thicker portion 18 to thereby prevent the life of the disk cutter 2D from becoming short. As shown in FIG. 9B, a notch 18b may be formed at each top corner of the thicker portion 18 in place of the chamfer 18a.

In the first to third and fifth preferred embodiments, each tip insert 10 is fixed to the corresponding tip support 6 by brazing after forming the thicker portion 12, 14, 16 or 18. Thereafter, each tip insert 10 is polished for finish. In this process, the thickness of the thicker portion 12, 14, 16 or 18 may be set slightly greater than the thickness T2 of the base portion 10d of each tip insert 10. Then, in polishing the opposite side surfaces of each tip insert 10 fixed to the corresponding tip support 6, the opposite side surfaces of the thicker portion 12, 14, 16 or 18 may be simultaneously polished until the specific thickness of the thicker portion 12, 14, 16 or 18 is reached. Further, the opposite side surfaces of the thicker portion 12, 14, 16 or 18 may be formed in parallel to the opposite side surfaces of the base disk 4. Alternatively, the opposite side surfaces of the thicker portion 12, 14, 16 or 18 may be inclined with respect to the opposite side surfaces of the base disk 4 at the same angle as the side centripetal angle E of each tip insert 10.

According to each preferred embodiment mentioned above, the thicker portion 12, 14, 16 or 18 formed on each tip support 6 comes close to a cut groove formed in cutting a work material. Accordingly, in the case that the outer circumference of the base disk 4 transversely vibrates due to the load applied in cutting the work material, the thicker portion 12, 14, 16 or 18 comes to contact with the inner side surfaces of the cut groove, thereby suppressing the transverse vibration of the base disk 4. Furthermore, since the thickness of the thicker portion 12, 14, 16 or 18 is set smaller than the thickness of the cutting edge 10c of each tip insert 10, a contact force between the thicker portion 12, 14, 16 or 18 and the inner side surfaces of the cut groove in normal operation without the transverse vibration is small, so that an increase in frictional heat can be prevented. Furthermore, since the thicker portion 12, 14, 16 or 18 is formed by increasing the thickness of the outer circumferential portion of the base disk 4, an increase in weight of the base disk 4 can be prevented and the structure of the base disk 4 can also be made simple.

According to the disk cutter 2B shown in FIG. 5, the thicker portion 16b is formed along the inner wall of each gullet 8. Accordingly, the thicker portion 16b comes to contact with the inner side surfaces of the cut groove, thereby enhancing a catching function of each gullet 8 for catching a chip in each gullet 8. As a result, the chip in each gullet 8 can be efficiently expelled to the outside thereof. This indicates that when a dust collector is mounted to the disk cutter 2B in cutting a new building material such as ALC and woody cement which is prone to generate dust, a dust collecting efficiency of chips generated from a work material can be increased by the dust collector, thereby improving a work environment.

The present invention is not limited to the details of the above described preferred embodiments. The scope of the invention is defined by the appended claims and all changes and modifications as fall within the equivalence of the scope of the claims are therefore to be embraced by the invention.

What is claimed is:

1. A disk cutter comprising:
an annular disk-shaped base adapted to be driven about an axis of rotation, said base having a first thickness;
a plurality of tip supports formed along the outer circumference of said base integrally therewith so that a gullet is defined between adjacent ones of said tip supports;
a plurality of tip inserts respectively fixed to said tip supports, each of said tip inserts having a second thickness; and
a plurality of thicker portions each formed along a trailing end of each tip support in respect of rotation of said base, said thicker portions having a third thickness;
said third thickness being greater than said first thickness and less than said second thickness.

2. The disk cutter according to claim 1, wherein said thicker portion is formed by plastic deformation of said outer circumference of each tip support.

3. A disk cutter comprising:
an annular disk-shaped base adapted to be driven about an axis of rotation, said base having a first thickness;
a plurality of tip supports formed along the outer circumference of said base integrally therewith so that a gullet is defined between adjacent ones of said tip supports;
a plurality of tip inserts respectively fixed to said tip supports, each of said tip inserts having a second thickness; and
a plurality of thicker portions each continuously formed over the range from the outer circumference of each tip support to the inner wall of said gullet between adjacent ones of said tip inserts, said thicker portions having a third thickness;
said third thickness being greater than said first thickness and less than said second thickness.

4. The disk cutter according to claim 3, wherein said thicker portion is formed by plastic deformation of the outer circumference of each tip support and the inner wall of said gullet.

5. A disk cutter comprising:
an annular disk-shaped base adapted to be driven about an axis of rotation, said base having a first thickness;
a plurality of tip supports formed along the outer circumference of said base integrally therewith so that a gullet is defined between adjacent ones of said tip supports;
a plurality of tip inserts respectively fixed to said tip supports, each of said tip inserts having a second thickness; and
a plurality of thicker portions each formed along a trailing end of each of some of said tip supports in respect of rotation of said base, said some of said tip supports being arranged at intervals of two or more tip supports, said thicker portions having a third thickness;
said third thickness being greater than said first thickness and less than said second thickness.

6. A disk cutter comprising:
an annular disk-shaped base adapted to be driven about an axis of rotation, said base being composed of an inner circumferential portion having a first thickness and an outer circumferential portion having a second thickness greater than said first thickness;
a plurality of tip supports formed along said outer circumference portion of said base integrally therewith so that a gullet is defined between adjacent ones of said tip supports; and
a plurality of tip inserts respectively fixed to said tip supports, each of said tip inserts having a third thickness;
said second thickness being less than said third thickness.
